(19) United States
(12) Patent Application Publication
(10) Pub. No.: US 2008/0264398 A1
(43) Pub. Date: Oct. 30, 2008

(54) Auxiliary Power Compensation During Map Testing

(75) Inventors: Steven Yellin Schondorf, Dearborn, MI (US); Tom Scott Gee, Canton, MI (US); John Shanahan, Harrison Township, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 11/740,360

(22) Filed: Apr. 26, 2007

(51) Int. Cl. F02D 41/00

(52) U.S. Cl. 123/674; 903/902

(57) ABSTRACT

A method for updating a map in a vehicle having an internal combustion engine and an auxiliary power source is provided. The method includes changing an input parameter; monitoring an actual output value corresponding to the changed input parameter; mapping the monitored actual output value to the changed input parameter; and compensating engine output with the auxiliary power source to account for changes to engine output resulting from changing the input parameter.

### FIELD

The present application relates to methods and systems to perform real-time validation and update of calibration maps of an internal combustion engine in a vehicle and compensate output of the vehicle using an auxiliary power source.

### BACKGROUND

Vehicle control systems may use various maps to control the operation of an internal combustion engine and/or other vehicle systems. A map can be used to set one or more variable engine parameters or other system parameters to achieve a desired vehicle response. Each changeable vehicle parameter can be referred to as an input parameter of the map, and each desired vehicle response can be referred to as an output value of the map. Nonlimiting examples of input parameters may include fuel injection amount, fuel injection timing, spark timing, air/fuel ratio, boost pressure, number of operating engine cylinders, electric motor assist, etc. Nonlimiting examples of output values may include engine output torque, engine speed, fuel economy, emissions, etc.

Vehicle control systems can adjust an aspect of an engine or other system according to an input parameter that is mapped to a desired output value. However, actual vehicle behavior may deviate from the vehicle behavior predicted by the maps under at least some operating conditions. Additionally, environmental factors such as local temperature, pressure, and humidity may affect the accuracy of the maps.

U.S. Pat. No. 6,928,361 discloses a control apparatus that changes the input control parameters so that each of the output values becomes substantially equal to a corresponding target output value. Then, the control apparatus determines adapted values of the input control parameters based on values of the input control parameters obtained when each of the output values becomes substantially equal to the corresponding target output value.

However, the inventors herein have recognized disadvantages with such a control apparatus. For example, as the control apparatus changes the input parameters searching for the desired output values, there can be noticeable changes in vehicle behavior, and such changes may be undesirable. Furthermore, the control apparatus may have to wait until operating conditions are suitable for making changes to the input parameters if such changes are likely to cause noticeable changes in engine output.

### SUMMARY

In one approach, a method for operating a powertrain of a hybrid vehicle, the powertrain including an internal combustion engine, an auxiliary power source, and an energy storage device may address the above concerns. The method may include providing output torque from the powertrain responsive to a driver request, where both the auxiliary power source and the engine provide the output torque, varying engine output relative to motor output in a coordinated common direction responsive to variation in the driver request in the common direction during a first operating mode; and varying engine output relative to motor output in a opposite directions and independent from the driver request, while still providing the driver request, during a second operating mode, where engine performance is evaluated relative to a parameter during the second mode to learn variation in engine operation.

In another approach, the above issues may be addressed by a method for updating a map in a vehicle having an internal combustion engine and an auxiliary power source. The method comprises changing an input parameter; monitoring an actual output value corresponding to the changed input parameter; mapping the monitored actual output value to the changed input parameter; and compensating engine output with the auxiliary power source to account for changes to engine output resulting from changing the input parameter.

In yet another approach, a method for updating a map in a vehicle having an internal combustion engine and an auxiliary power source is provided. The method comprises determining a desired output value; choosing an input parameter that is mapped to produce the desired output value; monitoring an actual output value produced by the chosen input parameters; changing the chosen input parameter to an adjusted input parameter; and supplementing a vehicle output with the auxiliary power source to compensate for changes to engine output resulting from changing the chosen input parameter to the adjusted input parameter.

### DESCRIPTION OF THE DRAWINGS

FIG. 1 is a schematic diagram of an engine in an example hybrid powertrain.

FIG. 2 is a schematic diagram of an engine, intake system, and exhaust system.

FIG. 3 schematically illustrates an exemplary map for an internal combustion engine in a vehicle.

FIG. 4 illustrates how the map shown in FIG. 3 can be used to achieve desired output values during a period of operation.

FIG. 5 shows an exemplary table illustrating a relationship between selected input parameters, actual output values, and predicted output values.

FIG. 6 shows an exemplary table illustrating how input parameters can be swept over time so that actual output values can be monitored.

FIG. 7A and 7B show change of output torque of a vehicle with time.

FIG. 8 shows change of output torque of a vehicle during a map update.

FIG. 9 illustrates a first exemplary method to calibrate and/or validate a map in a vehicle.

FIG. 10 illustrates a second exemplary method to calibrate and/or validate a map in a vehicle.

FIG. 11 illustrates a third exemplary method to calibrate and/or validate a map in a vehicle.

### DETAILED DESCRIPTION

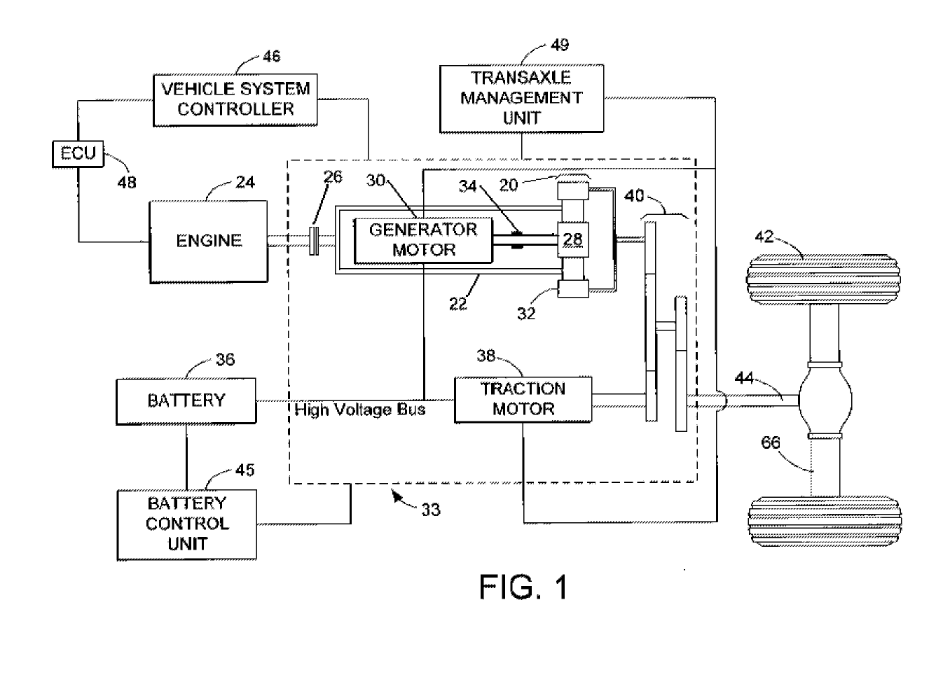

The present disclosure is directed to vehicles including two different power sources, such as, hybrid electric vehicles (HEVs). FIG. 1 demonstrates one possible configuration, specifically a parallel/series hybrid electric vehicle (split) configuration.

In an HEV, a planetary gear set 20 mechanically couples a carrier gear 22 to an engine 24 via a one way clutch 26. The planetary gear set 20 also mechanically couples a sun gear 28 to a generator motor 30 and a ring (output) gear 32. The generator motor 30 also mechanically links to a generator brake 34 and is electrically linked to an energy storage device, such as a battery 36. A traction motor 38 is mechanically coupled to the ring gear 32 of the planetary gear set 20 via a second gear set 40 and is electrically linked to the battery 36. The ring gear 32 of the planetary gear set 20 and the traction motor 38 are mechanically coupled to drive wheels 42 via an output shaft 44.

The planetary gear set 20, splits the engine 24 output energy into a series path from the engine 24 to the generator motor 30 and a parallel path from the engine 24 to the drive wheels 42. Engine speed can be controlled by varying the split to the series path while maintaining the mechanical connection through the parallel path. The traction motor 38 augments the engine power to the drive wheels 42 on the parallel path through the second gear set 40. The traction motor 38 also provides the opportunity to use energy directly from the series path, essentially running off power created by the generator motor 30. This reduces losses associated with converting energy into and out of chemical energy in the battery 36 and allows all engine energy, minus conversion losses, to reach the drive wheels 42.

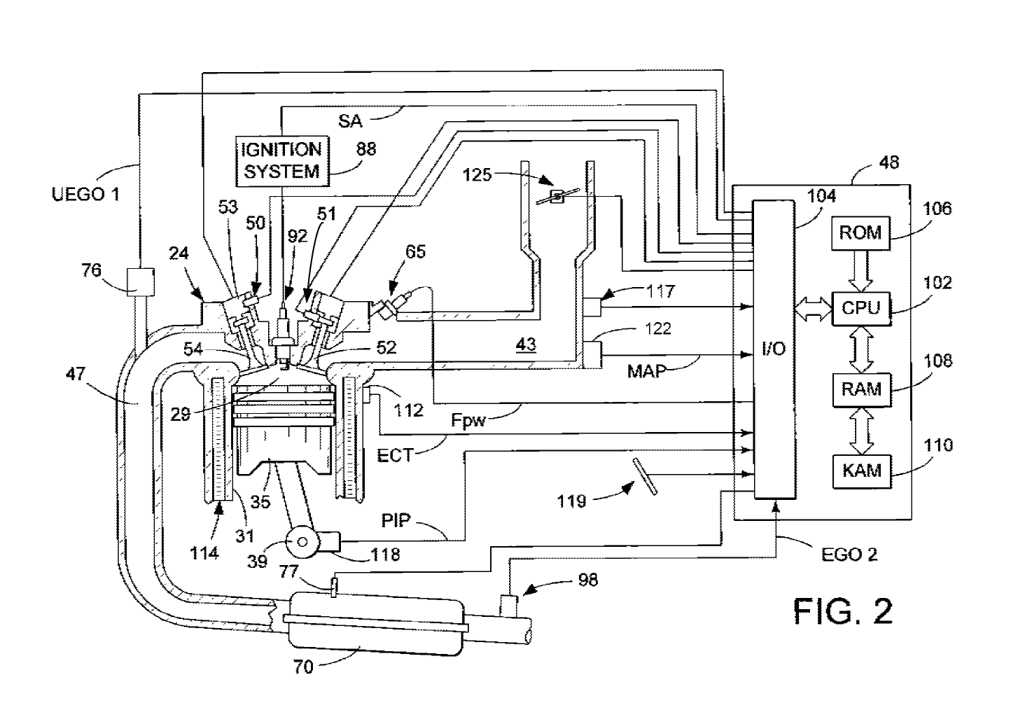

A vehicle system controller (VSC) 46 controls many components in this HEV configuration by connecting to each component's controller. An engine control unit (ECU) 48 connects to the Engine 24 via a hardwire interface (see further details in FIG. 2). In one example, the ECU 48 and VSC 46 can be placed in the same unit, but are actually separate controllers. Alternatively, they may be the same controller, or placed in separate units. The VSC 46 communicates with the ECU 48, as well as a battery control unit (BCU) 45 and a transaxle management unit (TMU) 49 through a communication network such as a controller area network (CAN) 33. The BCU 45 connects to the battery 36 via a hardware interface. The TMU 49 controls the generator motor 30 and the traction motor 38 via a hardwire interface. The control units 46, 48, 45 and 49, and controller area network 33 can include one or more microprocessors, computers, or central processing units; one or more computer readable storage devices; one or more memory management units; and one or more input/output devices for communicating with various sensors, actuators and control circuits.

It should be appreciated that FIG. 1 only demonstrates one configuration of an HEV. Any vehicle having an auxiliary power source may be used to implement the present disclosure. For example, the present disclosure may be useful in a fuel cell HEV, a gasoline HEV, an ethanol HEV, a flexfuel HEV, a hydrogen engine HEV, etc.

FIG. 2 shows an example engine 24 and exhaust system that may be used with the HEV system illustrated in FIG. 1. Internal combustion engine 24, comprising a plurality of cylinders, one cylinder of which is shown in FIG. 2, is controlled by electronic engine controller 48. Engine 24 includes combustion chamber 29 and cylinder walls 31 with piston 35 positioned therein and connected to crankshaft 39. Combustion chamber 29 is shown communicating with intake manifold 43 and exhaust manifold 47 via respective intake valve 52 and exhaust valve 54. Each intake and exhaust valve is operated by an electromechanically controlled valve coil and armature assembly 53. Armature temperature is determined by temperature sensor 51. Valve position is determined by position sensor 50. In an alternative example, each of valves actuators for valves 52 and 54 has a position sensor and a temperature sensor. In an alternative embodiment, cam actuated valves may be used with or without variable cam timing or variable valve lift.

Intake manifold 43 is also shown having fuel injector 65 coupled thereto for delivering liquid fuel in proportion to the pulse width of signal FPW from controller 48. Fuel is delivered to fuel injector 65 by fuel system (not shown) including a fuel tank, fuel pump, and fuel rail (not shown). Alternatively, the engine may be configured such that the fuel is injected directly into the engine cylinder, which is known to those skilled in the art as direct injection. In addition, intake manifold 43 is shown communicating with optional electronic throttle 125.

Distributorless ignition system 88 provides ignition spark to combustion chamber 29 via spark plug 92 in response to controller 48. Universal Exhaust Gas Oxygen (UEGO) sensor 76 is shown coupled to exhaust manifold 47 upstream of catalytic converter 70. Alternatively, a two-state exhaust gas oxygen sensor may be substituted for UEGO sensor 76. Two-state exhaust gas oxygen sensor 98 is shown coupled to exhaust manifold 47 downstream of catalytic converter 70. Alternatively, sensor 98 can also be a UEGO sensor. Catalytic converter temperature is measured by temperature sensor 77, and/or estimated based on operating conditions such as engine speed, load, air temperature, engine temperature, and/or airflow, or combinations thereof. Converter 70 can include multiple catalyst bricks, in one example. In another example, multiple emission control devices, each with multiple bricks, can be used. Converter 70 can be a three-way type catalyst in one example.

Controller 48 is shown in FIG. 2 as a conventional microcomputer including: microprocessor unit 102, input/output ports 104, and read-only memory 106, random access memory 108, 110 keep alive memory, and a conventional data bus. Controller 48 is shown receiving various signals from sensors coupled to engine 24, in addition to those signals previously discussed, including: engine coolant temperature (ECT) from temperature sensor 112 coupled to cooling sleeve 114; a position sensor 119 coupled to an accelerator pedal; a measurement of engine manifold pressure (MAP) from pressure sensor 122 coupled to intake manifold 43; a measurement (ACT) of engine air amount temperature or manifold temperature from temperature sensor 117; and an engine position sensor from a Hall effect sensor 118 sensing crankshaft 39 position. In one aspect of the present description, engine position sensor 118 produces a predetermined number of equally spaced pulses every revolution of the crankshaft from which engine speed (RPM) can be determined.

In an alternative embodiment, a direct injection type engine can be used where injector 65 is positioned in combustion chamber 29, either in the cylinder head similar to spark plug 92, or on the side of the combustion chamber.

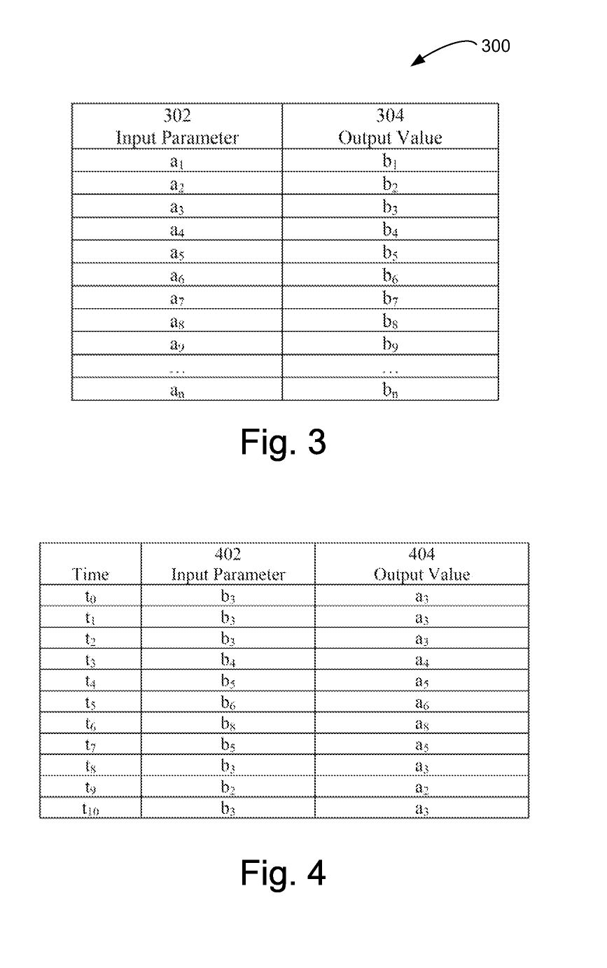

FIG. 3 illustrates an exemplary map for an internal combustion engine in a vehicle. The engine may include various maps to control engine operations. Map 300 is a simplified map provided for illustrative purposes. In map 300, a column 302 may include input parameters (as denoted by the letter “a”). The input parameters correspond to output values (as denoted by the letter “b”) listed in a column 304. It should be appreciated that maps can be more complicated, such as by including more than one type of input parameter and/or more than one type of output value. Similarly, it should be understood that a vehicle may utilize two or more different maps.

The input parameter may include, but is not limited to, fuel injection amount, fuel injection timing, spark timing, intake air flow, air/fuel ratio, boost pressure, number of operating engine cylinders, electric motor assist, etc. The output value may include, but is not limited to, engine output torque, engine speed, fuel economy, emissions, performance, etc. In one example, the input parameter may include a fuel injection amount and the output value may include an engine torque. The fuel injection amount (e.g., a₂) in map 300 corresponds to an output torque (e g., b₂).

An engine controller or a vehicle system controller may use one or more maps to control the operation of the engine or other vehicle system to achieve a desired output. FIG. 4 shows how map 300 can be used to achieve desired output values during a period of operation. Based on the desired output values listed in column 404, the engine controller may select input parameters mapped in column 402 in order to produce the desired output values. For example, when the desired output value is b₂ at time t₉, the engine controller can find the corresponding input value a₂ using map 300.

However, a map may not be accurate under at least some engine operating conditions. In some conditions, the engine in a specific vehicle may perform differently than the map predicts. For example, fuel economy, or emissions may vary from vehicle to vehicle, local climate to local climate, change as a vehicle ages, change with fuel quality, or otherwise vary from what is initially anticipated by a map. As used herein, the “performance sweet spot” may be described by preferable (or best) fuel consumption, torque, efficiency, etc.

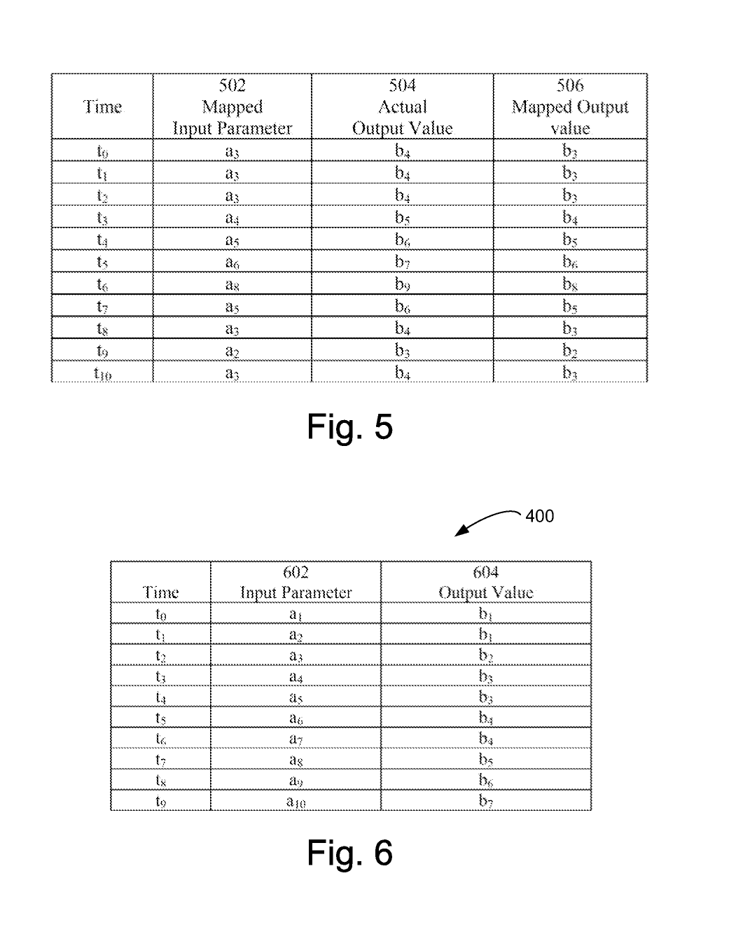

FIG. 5 shows an exemplary table illustrating a relationship between selected input parameters, shown in column 502, and the actual output values, shown in column 504, that may occur under at least some operating conditions. The table also shows the output values anticipated by the map in column 506. As shown in FIG. 5, mapped input parameters may not always produce the desired output values. For example, at time t₃, the desired output value is b₄ and the mapped input parameter is a₄. However, the actual output value is b₅ instead of the desired output value of b₄. As indicated by FIG. 5, the map may not always be accurate. Therefore, maps may be updated, amended and/or replaced as described herein.

In some embodiments, a map may be calibrated by testing actual vehicle behavior under actual operating conditions. FIG. 6 shows how input parameters can be swept over time (e.g., from t₀ to t₉) so that actual output values can be monitored. The results of such a test can be used to calibrate a map such as map 300 shown in FIG. 3. In some embodiments, input parameters may be selected for calibration as shown in column 602. The input parameter may be selected from a predetermined range and/or otherwise varied over time. The actual output values corresponding to the selected input parameters can be monitored and recorded, as shown in column 604. The actual output values that are monitored can be used to calibrate an old map or create a new map.

In some embodiments, the test may be performed by sweeping over an RPM range of interest. It is worth noting that in embodiments that utilize a powersplit hybrid design, the engine speed can be decoupled from the wheel speed, which allows a control system to sweep the engine speed independently of driver demand. Thus, the map may be updated by mapping the actual output values with the selected input parameters. In some embodiments, tested operating points may be selected such that the data from the testing may be sufficient to calibrate the map using any suitable calculation such as interpolation. Thus, a new map 400 may be created. In some embodiments, the new map may replace the previous map. For example, as the vehicle ages, a previous map may be outdated and may not be used.

In some embodiments, various maps may be saved, each map corresponding to a determined condition. For example, environmental variables such as temperature, pressure, humidity etc. may affect the performance of the vehicle. Thus, environmental variables may be recorded during the map update. The new map may be used at different environment or ambient conditions. It should be noted that any variables that affects the accuracy of the map may be associated with the new map.

In some embodiments, data in the map may be updated during normal engine operation through the searching of an input parameter that produces a desired output value. For example, if it is discovered that a particular input parameter does not produce a desired output value, different input parameters can be searched for and/or tested. The input parameter may be adjusted to find the input value that produces the desired output. A temporary or permanent adjustment may be made to the map to reflect the new input parameter.

The above described test and calibration can affect vehicle behavior. For example, when the engine is tested across a RPM range, the output torque may vary or fluctuate. The output torque may be higher or lower than a driver's demand as the RPMs are purposefully adjusted to monitor map performance. As a result, the driver may notice undesirable and/or unpredicted vehicle behavior.

In some embodiments, an output torque difference between the driver's demand and the actual output value by the engine during map calibration may be compensated by power output from an auxiliary power source. For example, a hybrid gas/electric vehicle can use its electric motor to compensate for changes in the gas engine output torque when the gas engine output is modified during map testing or calibration.

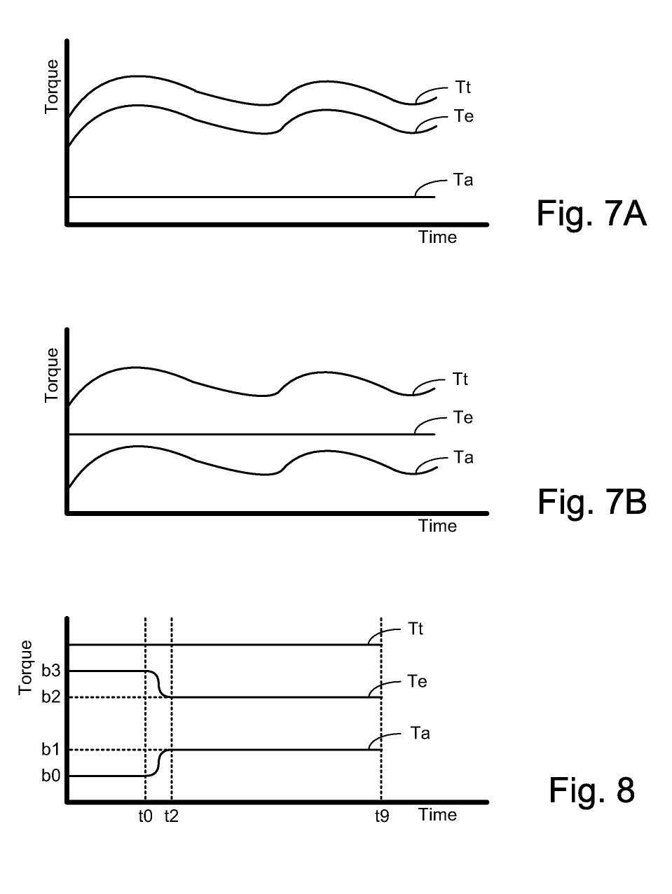

FIG. 7A shows the change of a vehicle's output torque with time. Line Ta shows an output torque from an auxiliary power source over time, illustrating a constant output. Line Te shows an output torque from an internal combustion engine over time. Line Tt shows a total output torque from the vehicle, which is the sum of the output torque from the engine and the output torque from the auxiliary power source. FIG. 7A shows that the output torque from the vehicle changes over time as the driver's demand changes. In some operating conditions, as shown in FIG. 7B, the output torque from the engine can be held constant while the output torque from the auxiliary source is adjusted to respond to driver's demand. Under at least some operating conditions, the output torque from the engine and the auxiliary source can be simultaneously adjusted.

FIG. 8 shows change of output torque of a vehicle during a map update. Lines Tt, Te, and Ta shows output torque from a vehicle, an internal combustion engine, and an auxiliary power source, respectively. For the purpose of simplification, it is assumed that the desired output torque from the vehicle is constant and the output torques from the engine and the auxiliary power source are constant except during the map update. FIG. 8 shows that the map is updated during the period from t₀ to t₂. As shown by line Te in FIG. 8, the output torque from the engine varies as the input parameters are swept across a range to test map accuracy. If the output torque from the auxiliary power source was maintained to be constant, the vehicle output torque would fluctuate following the pattern of the engine output torque. However, the output variation can be compensated by adjusting the power output from the auxiliary power source. For example, at time t₂, the output torque from the auxiliary power source may be increased from b₀ to b₁. The increase of the output torque from the auxiliary power source (b₁-b₀) may be set to cancel the decrease of the engine output torque (b₂-b₃). The engine output torque b₂ may be estimated based on the input parameter selected at t₂. It should be noted that any suitable method may be used to estimate the required compensation. For example, at t₂, an output torque mapped to the selected input parameter at t₂ may be used to estimate the compensation from the auxiliary power source. Alternatively, previously obtained data may be used to estimate the engine output torque at t₂ corresponding to the selected input parameter.

It is possible to adjust the power output from the auxiliary power source in response to variations in the engine output torque during map testing, validation, and/or calibration. The auxiliary power source can be used to compensate for anticipated changes in engine output torque when one or more input parameters are varied. Such variations to the input parameters may include sweeping across a range of input parameters or instead performing a targeted search for an input parameter that produces a particular output value.

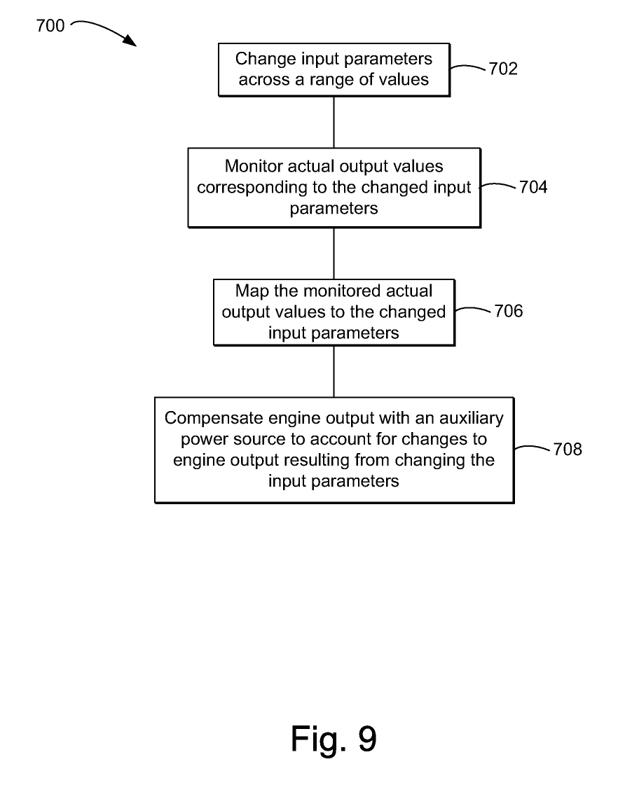

FIG. 9 illustrates a first exemplary method 700 to calibrate and/or validate a map in a vehicle. At 702, the method changes input parameters across a range of values. As described above with reference to FIG. 6, in some embodiments, the input parameters may be selected from a predetermined range. In other embodiments, the map calibration and/or validation may be performed by sweeping over a RPM range of interest. Alternatively, a single input parameter may be calibrated or validated during a specific time period.

At 704, the method monitors actual output values corresponding to the changed input parameters. In some embodiments, the output values may include, but are not limited to, the output torque, the brake specific fuel consumption, and emissions. In some embodiments, a hybrid vehicle generator motor may be used to monitor actual engine output torque.

At 706, the method maps the monitored actual output values to the changed input parameters. At 708, the method compensates engine output with an auxiliary power source to account for changes to engine output resulting from changing the input parameters.

As described above, the compensated engine output with the auxiliary power source can minimize undesirable vehicle behavior noticeable to a driver. Thus, the method allows an engine controller to calibrate and/or validate a map on a regular basis without waiting for particular conditions that may reduce the driver's feel to the changed parameters. With validated and accurate maps, the engine or vehicle can operate at least close to optimized conditions so that fuel economy, emissions and engine performance can be improved.

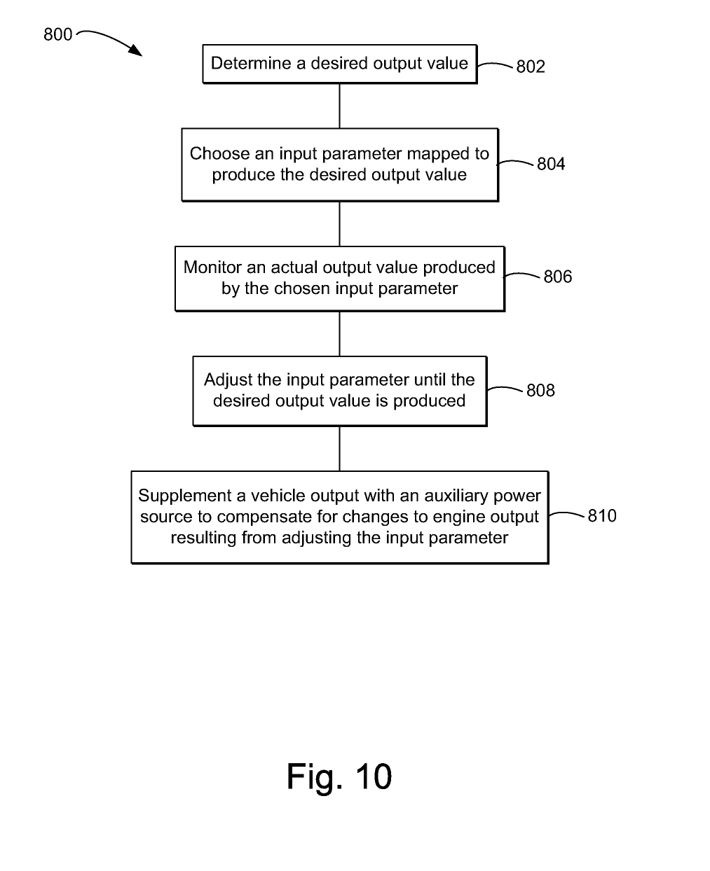

FIG. 10 illustrates a second exemplary method 800 to calibrate and/or validate a map in a vehicle. At 802, the method determines a desired output value. At 804, the method chooses an input parameter that is mapped to produce the desired output value. At 806, the method monitors an actual output value produced by the chosen input parameter. As described above with reference to FIG. 5, the mapped input parameter may not produce the desired output value. Thus, at 808, the method may adjust the input parameter until the desired output value is produced. At 810, the method supplements vehicle output with an auxiliary power source to compensate for changes to engine output resulting from adjusting the input parameter.

Similar to the first exemplary method described above, supplementing vehicle output allows the calibration and validation of the map without causing undesirable vehicle behavior noticeable by a driver.

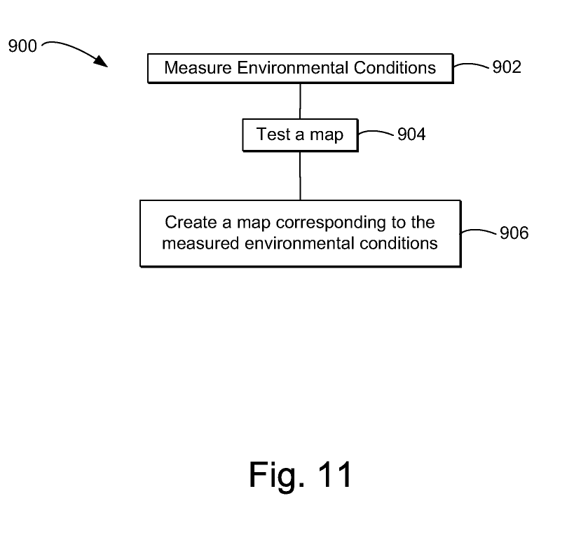

FIG. 11 illustrates a third exemplary method 900 to calibrate and/or validate a map in a vehicle. At 902, the method measures environmental conditions during a map calibration and/or validation. The environment conditions may include, but not limited to, ambient temperature, pressure, and humidity. At 904, the method tests a map. In some embodiments, the map may be tested using the method 700 described in FIG. 9. In other embodiments, the map may be tested using the method 800 described in FIG. 10. It should be noted that testing the map may include a step to compensate vehicle output torque with an auxiliary power source as desired to improve a driver's feel during map testing. At 906, the method creates a map instance corresponding to the measured environmental conditions.

In addition to advantages described above, the method 900 captures the environmental variations. Thus, the map may be accurate at the measured environment conditions.

A new map or modified map allows a vehicle to be operated at conditions that can achieve desirabale performance such as the best brake-specific fuel consumption and/or the best torque.

It should be noted that map updating or remapping may be performed as a diagnostic procedure. For example, remapping may be done while the vehicle is connected to “rolls” or a dynamometer in the assembly plant.

It will be appreciated that the processes disclosed herein are exemplary in nature, and that these specific embodiments are not to be considered in a limiting sense, because numerous variations are possible. The subject matter of the present disclosure includes all novel and non-obvious combinations and subcombinations of the various structures, and other features, functions, and/or properties disclosed herein.

For example, in one approach, a method for updating a map in a vehicle having an internal combustion engine is provided. The method comprises measuring environmental conditions;_testing the map under the measured environmental conditions; and creating a map instance corresponding to the measured environmental conditions, where the created map instance produces desired output values for mapped input variables at the measured environment conditions. The method may further comprise supplementing an engine output torque using an auxiliary power source during testing to maintain a desired output torque by an operator of the vehicle, wherein testing the map comprises: changing an input parameter; monitoring an actual output value from the engine corresponding to the changed input parameter; and mapping the monitored actual output value to the changed input parameter. Further, the environmental conditions may include one of local temperature, local pressure, and local humidity.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of methods and system component configurations, processes, apparatuses, and/or other features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a powertrain of a hybrid vehicle, the powertrain including an internal combustion engine, an auxiliary power source, and an energy storage device, the method comprising:
providing output torque from the powertrain responsive to a driver request, where both the auxiliary power source and the engine provide the output torque,
varying engine output relative to motor output in a coordinated common direction responsive to variation in the driver request in the common direction during a first operating mode; and
varying engine output relative to motor output in a opposite directions and independent from the driver request, while still providing the driver request, during a second operating mode, where engine performance is evaluated relative to a parameter during the second mode to learn variation in engine operation.

2. The method of claim 1 where during the second mode, engine operation is varied across a preselected range and varied independently from the driver request, where the auxiliary power source compensates for the engine variation, where engine calibration maps are updated based on the evaluation.

3. A method for updating a map in a vehicle, the vehicle including an internal combustion engine and an auxiliary power source, the method comprising:
changing an input parameter;
monitoring an actual output value corresponding to the changed input parameter;
mapping the monitored actual output value to the changed input parameter; and
compensating engine output with the auxiliary power source to account for changes to engine output resulting from changing the input parameter.

4. The method of claim 3, wherein the output value is engine output torque and/or a fuel efficiency.

5. The method of claim 4, wherein the input parameter is engine speed.

6. The method of claim 3, wherein input parameters are swept across a range of values; actual output values are monitored and mapped to the corresponding input parameters, and the engine output is compensated throughout the range.

7. The method of claim 3, wherein mapping the monitored actual output value to the changed input parameter includes overwriting a previous map.

8. The method of claim 3, wherein mapping the monitored actual output value to the changed input parameter includes creating a new map in addition to a previous map.

9. The method of claim 3, wherein mapping the monitored actual output value to the changed input parameter includes creating correction factors that are applied to an original map.

10. The method of claim 3, wherein the input parameter includes one of fuel injection amount, fuel injection timing, spark timing, air/fuel ratio, boost pressure, and number of operating engine cylinders.

11. The method of claim 1, wherein the output parameters includes one of engine output torque, engine speed, fuel economy, and emissions, and wherein the auxiliary power source is a hybrid electric motor.

12. A method for updating a map in a vehicle, the vehicle including an internal combustion engine and an auxiliary power source, the method comprising:
determining a desired output value;
choosing an input parameter that is mapped to produce the desired output value;
monitoring an actual output value produced by the chosen input parameter;
changing the chosen input parameter to an adjusted input parameter; and
supplementing a vehicle output with the auxiliary power source to compensate for changes to engine output resulting from changing the chosen input parameter to the adjusted input parameter.

13. The method of claim 12, wherein the engine output is an engine output torque.

14. The method of claim 12, wherein the auxiliary power source is a hybrid electric motor.

15. The method of claim 12, further comprising mapping a tested input parameter that actually produces the desired output value to the desired output value.

16. The method of claim 15, wherein mapping the tested input parameter with the desired output value includes amending the data in the previous map.

17. The method of claim 15 further including updating a map in the vehicle, wherein the map is tested over measured environmental conditions, and where the updated based on engine output over the measured environmental conditions.
